(19) United States
(12) Patent Application Publication
(10) Pub. No.: US 2026/0009503 A1
(43) Pub. Date: Jan. 8, 2026

(54) A FUEL CELL SYSTEM HAVING A SECONDARY HYDROGEN STORAGE TANK TO AVOID SHUTTING DOWN THE FUEL CELL SYSTEM DURING REFUELING

(71) Applicant: Volvo Truck Corporation, Göteborg (SE)

(72) Inventors: Pranav ARYA, Göteborg (SE); Sigurd SONDEREGGER, Askim (SE); Ricard BLANC, Mölndal (SE)

(21) Appl. No.: 18/997,210

(22) PCT Filed: Aug. 3, 2022
(86) PCT No.: PCT/IB2022/057207

§ 371 Date: Jan. 21, 2025

(51) Int. Cl. F17C 5/00; B60L 50/70; F17C 13/04; H01M 8/04746; H01M 8/04955

(52) U.S. Cl. CPC F17C 5/00; F17C 13/04; H01M 8/04753; H01M 8/04955; B60L 50/70; F17C 2205/0326; F17C 2221/012; F17C 2223/0123; F17C 2225/0123; F17C 2227/04; F17C 2250/032; F17C 2270/0168

(57) ABSTRACT

A method in a continuous hydrogen delivery system having a plurality of primary hydrogen fuel tanks and at least one primary hydrogen fuel tank of the plurality of primary hydrogen fuel tanks acting as a secondary hydrogen fuel tank during refueling to maintain availability of hydrogen to fuel consumers during refueling of the primary hydrogen fuel tanks. The method further includes responsive to determining that the primary hydrogen fuel tanks is set up for refueling: before the refueling process begins: disconnecting the primary hydrogen fuel tanks from the primary fuel consumer while maintaining a connection of the secondary hydrogen fuel tank to at least one of the primary fuel consumer and the secondary fuel consumer. The method further includes after the tanks have been refueled: connecting the primary and the secondary hydrogen fuel tanks to at least one of the primary fuel consumer and the secondary fuel consumer.

### TECHNICAL FIELD

The disclosure relates generally to fuel cell systems. In particular embodiments, the disclosure relates to a fuel cell system having a hydrogen storage tank used to avoid shutting down the fuel cell system during refueling.

The disclosure can be applied in heavy-duty vehicles, such as trucks, buses, and construction equipment. Although the invention will be described with respect to a particular vehicle, the invention is not restricted to any particular vehicle.

### BACKGROUND

As electric vehicle adoption continues to increase, efficient energy storage becomes increasingly valuable. For example, on fuel-cell electric vehicles (FCEVs), there is a need for storing energy in both batteries and onboard hydrogen fuel tanks. A fuel cell must be shut down during refueling of hydrogen. This is not acceptable from a fuel cell lifetime perspective as additional shutdowns will result in faster degradation of the fuel cell system and should be avoided. Additionally, this is also not acceptable from a customer perspective as fuel cell shutdown and start up are time consuming.

As the Hydrogen fill station makes a leak tightness check on the vehicle by lifting the pressure on the vehicle side with a small amount of hydrogen, and then monitor the pressure. If the pressure is stable, the vehicle system is regarded leak tight, and the real filling process starts. The fuel consumption of the fuel cell during the fill process will be translated into leakage, as the pressure is not stable, and this will stop the filling procedure.

### SUMMARY

According to some embodiments, a method in continuous hydrogen delivery system having a plurality of primary hydrogen fuel tanks and at least one primary hydrogen fuel tank of the plurality of primary hydrogen fuel tanks acting as a secondary hydrogen fuel tank during refueling to maintain availability of hydrogen to one or more fuel consumers during refueling of a plurality of the plurality of primary hydrogen fuel tanks includes determining whether the plurality of primary hydrogen fuel tanks is set up for refueling. The method includes responsive to determining that that the plurality of primary hydrogen fuel tanks is set up for refueling and before the refueling process begins: disconnecting a plurality of the plurality of primary hydrogen fuel tanks from the primary fuel consumer and the secondary fuel consumer while maintaining a connection of the secondary hydrogen fuel tank to at least one of the primary fuel consumer and the secondary fuel consumer. The method includes after the plurality of primary hydrogen tanks have been refueled: connecting the plurality of the plurality of primary hydrogen fuel tanks and the secondary hydrogen fuel tank to at least one of the primary fuel consumer and the secondary fuel consumer.

According to additional embodiments, a continuous hydrogen delivery system includes a plurality of primary hydrogen fuel tanks configured to provide hydrogen fuel to a primary fuel consumer and a secondary fuel consumer. The continuous hydrogen delivery system includes at least one primary hydrogen fuel tank of the plurality of primary hydrogen fuel tanks configured to act as a secondary hydrogen fuel tank during refueling to maintain availability of hydrogen to one or more fuel consumers during refueling of a plurality of the plurality of primary hydrogen fuel tanks. The continuous hydrogen delivery system includes a first valve connected between the plurality of primary hydrogen fuel tanks and the secondary hydrogen fuel tank. The continuous hydrogen delivery system includes a second valve connected between the plurality of primary hydrogen fuel tanks and the primary fuel consumer. The continuous hydrogen delivery system includes a third valve connected between the plurality of primary hydrogen fuel tanks and the secondary fuel consumer. The continuous hydrogen delivery system includes a controller configured to perform operations including: determining whether the plurality of primary hydrogen fuel tanks is set up for refueling; responsive to determining that the plurality of primary hydrogen fuel tanks is set up for refueling: before the refueling process begins: disconnecting a plurality of the plurality of primary hydrogen fuel tanks from the primary fuel consumer while maintaining a connection of the secondary hydrogen fuel tank to at least one of the primary fuel consumer and the secondary fuel consumer; and after the plurality of primary hydrogen tanks have been refueled: connecting the plurality of the plurality of primary hydrogen fuel tanks (102) and the secondary hydrogen fuel tank to at least one of the primary fuel consumer (102) and the secondary fuel consumer.

According to some further embodiments, a computer program product having a non-transitory storage medium includes program code to be executed by processing circuitry of a controller, whereby execution of the program code causes the controller to perform operations including determining whether a plurality of primary hydrogen fuel tanks is set up for refueling. The operations include responsive to determining that the plurality of primary hydrogen fuel tanks is set up for refueling: before the refueling process begins: disconnecting a plurality of the plurality of primary hydrogen fuel tanks from the primary fuel consumer and the secondary fuel consumer while maintaining a connection of the secondary hydrogen fuel tank to at least one of the primary fuel consumer and the secondary fuel consumer. The operations include after the plurality of primary hydrogen tanks have been refueled: connecting the plurality of the plurality of primary hydrogen fuel tanks and the secondary hydrogen fuel tank to at least one of the primary fuel consumer and the secondary fuel consumer.

According to some further embodiments, a computer program product having a non-transitory storage medium includes program code to be executed by processing circuitry of a controller, whereby execution of the program code causes the controller to perform operations including determining whether a plurality of primary hydrogen fuel tanks is set up for refueling. The operations include responsive to determining that the plurality of primary hydrogen fuel tanks is set up for refueling: before the refueling process begins: disconnecting a plurality of the plurality of primary hydrogen fuel tanks from the primary fuel consumer and the secondary fuel consumer while maintaining a connection of the secondary hydrogen fuel tank to at least one of the primary fuel consumer and the secondary fuel consumer. The operations include after the plurality of primary hydrogen tanks have been refueled: connecting the plurality of the plurality of primary hydrogen fuel tanks and the secondary hydrogen fuel tank to at least one of the primary fuel consumer and the secondary fuel consumer.

In certain examples, the method includes disconnecting the plurality of the plurality of primary hydrogen fuel tanks from the primary fuel consumer by commanding a valve to open.

In certain examples, the method includes transmitting a command to the primary fuel consumer to reducing a hydrogen fuel draw during refueling of the plurality of primary hydrogen fuel tanks

In certain examples, the method includes wherein maintaining the connection of the at least one secondary hydrogen fuel tank to one of the primary fuel consumer and the secondary fuel consumer by maintaining the connection of the at least one secondary hydrogen fuel tank to the secondary fuel consumer.

According to some other embodiments, a method in a continuous hydrogen delivery system having a plurality of primary hydrogen fuel tanks and at least one secondary hydrogen fuel tank to maintain availability of hydrogen to a primary fuel consumer during refueling of at least one of the plurality of primary hydrogen tanks includes determining whether the plurality of primary hydrogen fuel tanks is set up for refueling. The method includes responsive to determining that that the plurality of primary hydrogen fuel tanks is set up for refueling and before the refueling process begins: disconnecting the plurality of primary hydrogen fuel tanks from the primary fuel consumer and connecting the at least one secondary hydrogen fuel tank to the primary fuel consumer, thereby maintaining availability of hydrogen to the primary fuel consumer during refueling of the plurality of primary hydrogen fuel tanks. After the plurality of primary hydrogen tanks have been refueled, the method includes: disconnecting the at least one secondary hydrogen fuel tank from the primary fuel consumer and connecting the plurality of primary hydrogen fuel tanks to the primary fuel consumer.

According to additional embodiments, a continuous hydrogen delivery system includes a plurality of primary hydrogen fuel tanks configured to provide hydrogen fuel to a primary fuel consumer. The continuous hydrogen delivery system includes at least one secondary hydrogen fuel tank configured to provide hydrogen fuel to the primary fuel consumer while the plurality of primary hydrogen tanks is being refueled. The continuous hydrogen delivery system includes a first switchable two port two position valve for connecting and disconnecting the at least one secondary hydrogen fuel tank with the plurality of primary hydrogen fuel tanks. The continuous hydrogen delivery system includes at least one multiple port multiple position valve for connecting and disconnecting the plurality of primary hydrogen fuel tanks and the at least one secondary hydrogen fuel tank to the primary fuel consumer.

According to some further embodiments, a computer program product having a non-transitory storage medium includes program code to be executed by processing circuitry of a controller, whereby execution of the program code causes the controller to perform operations including determining whether a plurality of primary hydrogen fuel tanks is set up for refueling. The operations include responsive to determining that the plurality of primary hydrogen fuel tanks is set up for refueling: before the refueling process begins: disconnecting the plurality of primary hydrogen fuel tanks from a primary fuel consumer and connecting at least one secondary hydrogen fuel tank to the primary fuel consumer, thereby maintaining availability of hydrogen to the primary fuel consumer during refueling of the plurality of primary hydrogen fuel tanks. The operations include after the plurality of primary hydrogen tanks have been refueled: disconnecting the at least one secondary hydrogen fuel tank from the primary fuel consumer and connecting the plurality of primary hydrogen tanks to the primary fuel consumer.

A computer program having program code to be executed by processing circuitry of a controller, whereby execution of the program code causes the controller to perform operations including determining whether a plurality of primary hydrogen fuel tanks is set up for refueling. The operations include responsive to determining that the plurality of primary hydrogen fuel tanks is set up for refueling: before the refueling process begins: disconnecting the plurality of primary hydrogen fuel tanks from a primary fuel consumer and connecting at least one secondary hydrogen fuel tank to the primary fuel consumer, thereby maintaining availability of hydrogen to the primary fuel consumer during refueling of the plurality of primary hydrogen fuel tanks. The operations include after the plurality of primary hydrogen tanks have been refueled: disconnecting the at least one secondary hydrogen fuel tank from the primary fuel consumer and connecting the plurality of primary hydrogen tanks to the primary fuel consumer.

According to an embodiment of the disclosure, a method in a continuous hydrogen delivery system having a plurality of primary hydrogen fuel tanks and at least one secondary hydrogen fuel tank to maintain availability of hydrogen to a primary fuel consumer during refueling of at least one of the plurality of primary hydrogen tanks includes determining whether the plurality of primary hydrogen fuel tanks is set up for refueling. The method further includes responsive to determining that that the plurality of primary hydrogen fuel tanks is set up for refueling and before the refueling process begins: disconnecting the plurality of primary hydrogen fuel tanks from the primary fuel consumer and connecting the at least one secondary hydrogen fuel tank to the primary fuel consumer, thereby maintaining availability of hydrogen to the primary fuel consumer during refueling of the plurality of primary hydrogen fuel tanks. After the plurality of primary hydrogen tanks have been refueled, the method further includes: disconnecting the at least one secondary hydrogen fuel tank from the primary fuel consumer and connecting the plurality of primary hydrogen tanks to the primary fuel consumer.

According to another embodiment, the primary fuel consumer is a fuel cell electric vehicle.

In certain examples, the method includes connecting the at least one secondary hydrogen fuel tank to a secondary fuel consumer during normal operation. The method includes disconnecting the at least one secondary hydrogen fuel tank from the secondary fuel consumer before the refueling process begins. The method includes connecting the at least one secondary hydrogen fuel tank to the secondary fuel consumer after the plurality of primary hydrogen tanks have been refueled.

In certain examples, the method includes connecting the at least one secondary hydrogen fuel tank to a secondary fuel consumer during normal operation. The method includes maintaining the connection to the secondary fuel consumer when the at least one secondary hydrogen fuel tank is connected to the primary fuel consumer.

In certain examples, the secondary fuel consumer is a hydrogen catalytic heater.

In certain examples, the method further includes reducing a power level of the primary fuel consumer during the refueling process to reduce fuel consumption during the refueling process.

In certain examples, the method further includes determining whether the at least one secondary hydrogen fuel tank has to be refueled. The method includes responsive to determining that the at least one secondary hydrogen fuel tank has to be refueled and before the refueling process begins: disconnecting the plurality of primary hydrogen fuel tanks from the primary fuel consumer and disconnecting the at least one secondary hydrogen fuel tank from the primary fuel consumer if connected to the primary fuel consumer or from the secondary fuel consumer if connected to the secondary fuel consumer. The method includes responsive to determining that the at least one secondary hydrogen fuel tank has to be refueled and after the at least one secondary hydrogen fuel tank has been refueled: connecting the plurality of primary hydrogen tanks to the primary fuel consumer and connecting the at least one secondary hydrogen tank to the secondary fuel consumer if the secondary fuel consumer is present.

In certain examples, the method includes sizing the at least one secondary hydrogen fuel tank based on fuel consumption and how long a shutdown of the primary fuel consumer needs to be avoided during refueling of the plurality of primary hydrogen fuel tanks.

According to another embodiment of the disclosure, a continuous hydrogen delivery system includes a plurality of primary hydrogen fuel tanks configured to provide hydrogen fuel to a primary fuel consumer. The continuous hydrogen delivery system includes at least one secondary hydrogen fuel tank configured to provide hydrogen fuel to the primary fuel consumer while the plurality of primary hydrogen tanks is being refueled. The continuous hydrogen delivery system includes a first switchable two port two position valve for connecting and disconnecting the at least one secondary hydrogen fuel tank with the plurality of primary hydrogen fuel tanks. The continuous hydrogen delivery system includes at least one multiple port multiple position valve for connecting and disconnecting the plurality of primary hydrogen fuel tanks and the at least one secondary hydrogen fuel tank to the primary fuel consumer.

In certain examples, the continuous hydrogen delivery system further includes a controller to control the first switchable two port two position valve and the at least one multiple port multiple position valve.

In certain examples, the at least one multiple port multiple position valve comprises a switchable three port two position valve, wherein in a first position of the switchable three port two position valve, the plurality of primary hydrogen fuel tanks is connected to the primary fuel consumer and the at least one secondary hydrogen fuel tank is disconnected from the primary fuel consumer, and wherein in a second position of the switchable three port two position valve, the at least one secondary hydrogen fuel tank is connected to the primary fuel consumer and the plurality of primary hydrogen fuel tanks are disconnected from the primary fuel consumer to enable the plurality of primary hydrogen fuel tanks to be refueled.

In certain examples, the at least one multiple port multiple position valve comprises a switchable four port two position valve, wherein in a first position of the switchable four port two position valve, the plurality of primary hydrogen fuel tanks is connected to the primary fuel consumer and the at least one secondary hydrogen fuel tank is connected to a secondary fuel consumer, and wherein in a second position of the switchable four port two position valve, the at least one secondary hydrogen fuel tank is connected to the primary fuel consumer and the plurality of primary hydrogen fuel tanks is disconnected from the primary fuel consumer and the secondary fuel consumer to enable the plurality of primary hydrogen fuel tanks to be refueled.

In certain examples, the at least one multiple port multiple position valve comprises a switchable four port three position valve, wherein in a first position of the switchable four port three position valve, the plurality of primary hydrogen fuel tanks is connected to the primary fuel consumer and the at least one secondary hydrogen fuel tank is connected to a secondary fuel consumer; wherein in a second position of the switchable four port three position valve, the at least one secondary hydrogen fuel tank is connected to the primary fuel consumer and the plurality of primary hydrogen fuel tanks is disconnected from the primary fuel consumer and the secondary fuel consumer to enable the plurality of primary hydrogen tanks to be refueled, and wherein in a third position of the switchable four port three position valve, the at least one secondary hydrogen fuel tank is connected to the secondary fuel consumer and the plurality of primary hydrogen fuel tanks is disconnected from the primary fuel consumer and the secondary fuel consumer to enable the plurality of primary hydrogen tanks to be refueled.

The at least one multiple port multiple position valve further includes a second switchable two port two position valve wherein when the four port three position valve is in the third position, the second switchable two port two position valve is in a first position to provide hydrogen fuel to the primary fuel consumer via the switchable four port three position valve and the at least one secondary hydrogen fuel tank and when the switchable four port three position valve is in the first position or the second position, the second switchable two port two position valve is in a second position to disconnect the primary fuel consumer from the switchable four port three position valve via the second switchable two port two position valve.

In certain examples, the continuous hydrogen delivery system further includes a second switchable four port two position valve, wherein in a first position, the plurality of primary hydrogen fuel tanks is connected to the at least one multiple port multiple position valve for providing hydrogen fuel to the primary fuel consumer and the at least one secondary fuel tank is connected to the at least one multiple port multiple position valve for providing hydrogen fuel to the secondary fuel consumer and wherein in a second position, the plurality of primary hydrogen fuel tanks and the at least one secondary hydrogen fuel tank are disconnected from the at least one multiple port multiple position valve.

In certain examples, the continuous hydrogen delivery system further includes a first pressure and flow conditioning module positioned between the at least one multiple port multiple position valve and the primary fuel consumer.

In certain examples, the continuous hydrogen delivery system further includes a second pressure and flow conditioning module positioned between the at least one multiple port multiple position valve and the secondary fuel consumer.

In certain examples, the continuous hydrogen delivery system further includes a shut-off valve between the second pressure and flow conditioning module and the at least one multiple port multiple position valve.

In certain examples, the primary fuel consumer is a fuel cell electric vehicle

In certain examples, the secondary fuel consumer is a hydrogen catalytic heater

Additional features and advantages are disclosed in the following description, claims, and drawings, and in part will be readily apparent therefrom to those skilled in the art or recognized by practicing the embodiments as described herein.

### BRIEF DESCRIPTION OF THE DRAWINGS

With reference to the appended drawings, below follows a more detailed description of embodiments of the invention cited as examples.

FIG. 1 illustrates a continuous hydrogen delivery system where a plurality of primary hydrogen fuel tanks with at least one primary hydrogen fuel tank designated to operates as a secondary hydrogen fuel tank during refueling are providing hydrogen fuel to a primary fuel consumer and a secondary fuel consumer according to some embodiments;

FIG. 2 illustrates the continuous hydrogen delivery system of FIG. 1 where the at least one primary hydrogen fuel tank is operating as a secondary hydrogen fuel tank during refueling of the plurality of primary hydrogen fuel tanks to provide hydrogen fuel to the primary fuel consumer and/or the secondary fuel consumer according to some embodiments;

FIG. 3 illustrates the continuous hydrogen delivery system of FIG. 2 where the at least one primary hydrogen fuel tank operating as the second hydrogen fuel tank consists of a plurality of primary hydrogen fuel tanks according to some embodiments;

FIG. 4 is a schematic diagram of a controller according to one example;

FIG. 5 is a flow chart of a method to maintain availability of hydrogen to a primary fuel consumer during refueling of at least one of a plurality of primary hydrogen fuel tanks according to one example;

FIG. 6 is a flowchart of a method to reduce hydrogen fuel draw during refueling of the plurality of primary hydrogen tanks according to one example;

FIG. 7 illustrates a continuous hydrogen delivery system where primary hydrogen fuel tanks are providing hydrogen fuel to a primary fuel consumer according to one example.

FIG. 8 illustrates a continuous hydrogen delivery system where secondary hydrogen fuel tank(s) are providing hydrogen fuel to the primary fuel consumer according to one example.

FIG. 9 is a flow chart of a method to maintain availability of hydrogen to a primary fuel consumer during refueling of at least one of a plurality of primary hydrogen fuel tanks according to one example.

FIG. 10 illustrates a continuous hydrogen delivery system where primary hydrogen fuel tanks are providing hydrogen fuel to a primary fuel consumer and secondary hydrogen fuel tank(s) are providing hydrogen fuel to a secondary fuel consumer according to one example.

FIG. 11 illustrates a continuous hydrogen delivery system where primary hydrogen fuel tanks are disconnected from providing hydrogen fuel to a primary fuel consumer to enable refueling of the primary hydrogen fuel tanks and secondary hydrogen fuel tank(s) are providing hydrogen fuel to the primary fuel consumer during the refueling according to one example.

FIGS. 12-13 are flow charts illustrating methods to maintain availability of hydrogen to a primary fuel consumer during refueling of at least one of a plurality of primary hydrogen fuel tanks according to examples.

FIG. 14 is a flow chart of a method to reduce hydrogen fuel draw from a primary fuel consumer during refueling of the primary hydrogen fuel tanks.

FIG. 15 illustrates a continuous hydrogen delivery system where a switchable four port three position valve is in a first position where primary hydrogen fuel tanks provide hydrogen fuel to the primary fuel consumer and secondary hydrogen fuel tanks provide hydrogen fuel to the secondary fuel consumer according to one example.

FIG. 16 illustrates a continuous hydrogen delivery system where a switchable four port three position valve is in a second position where primary hydrogen fuel tanks are disconnected from providing hydrogen fuel to the primary fuel consumer and secondary hydrogen fuel tank(s) provide hydrogen fuel to the primary fuel consumer and not the secondary consumer according to one example.

FIG. 17 illustrates a continuous hydrogen delivery system where a switchable four port three position valve is in a third position where primary hydrogen fuel tanks are disconnected from providing hydrogen fuel to the primary fuel consumer and secondary hydrogen fuel tanks provide hydrogen fuel to the secondary fuel consumer according to one example.

FIG. 18 illustrates the continuous hydrogen delivery system of FIG. 11 where the switchable four port three position valve is in the third position and a switchable two port two position valve is connected to a port of the third position of the switchable four port three position valve where the secondary hydrogen fuel tank(s) provide hydrogen fuel to the secondary fuel consumer and to the primary fuel consumer via the switchable two port two position valve according to one example.

FIG. 19 is a flow chart of a method to refuel the secondary hydrogen fuel tank(s) according to one example.

FIG. 20 illustrates a continuous hydrogen delivery system where a switchable four port two position valve is in a first position to provide hydrogen fuel to the primary fuel consumer by the primary hydrogen fuel tanks and provide hydrogen fuel to the secondary fuel consumer by the secondary hydrogen fuel tank(s) according to one example.

FIG. 21 illustrates a continuous hydrogen delivery system where a switchable four port two position valve is in a second position where no hydrogen fuel is provided to the primary fuel consumer or the secondary fuel consumer and the secondary hydrogen fuel tank(s) are being refueled according to one example.

FIG. 22 is a flow chart of a method to size the secondary hydrogen fuel tank(s) according to one example.

### DETAILED DESCRIPTION

The embodiments set forth below represent the necessary information to enable those skilled in the art to practice the embodiments and illustrate the best mode of practicing the embodiments.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

When a valve (e.g., inline solenoid valve, on-line tank valve, etc.) is open, the input and output of the valve are fluidly connected, and hydrogen fuel can flow through the valve. When a valve is closed, the input and output of the valve are not fluidly connected, and no hydrogen fuel flows through the valve.

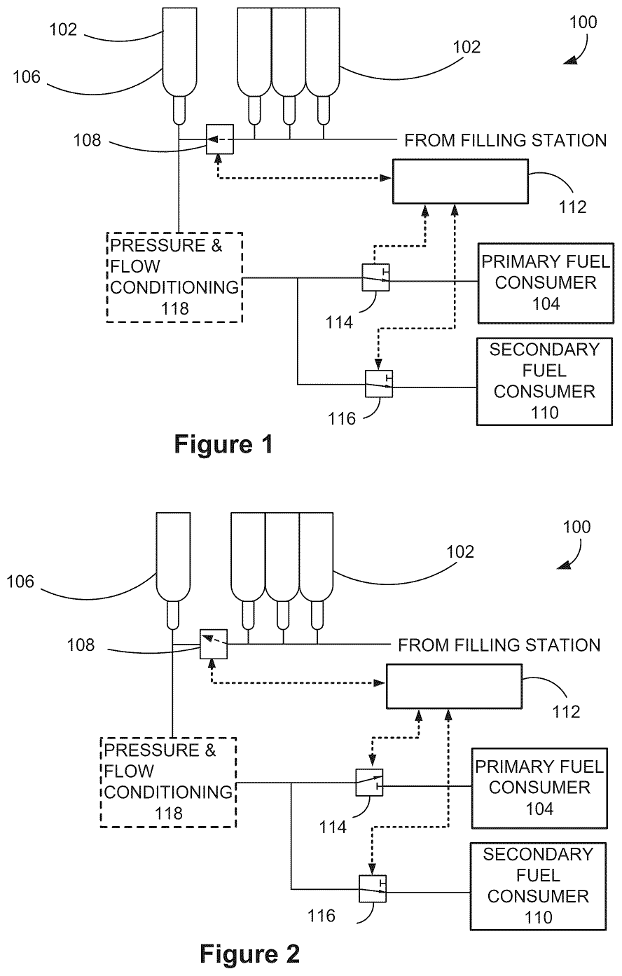

FIG. 1 illustrates a continuous hydrogen delivery system 100 having a plurality of primary hydrogen fuel tanks 102 providing fuel to a primary fuel consumer 104. At least one of the primary hydrogen fuel tanks 102 operates as a secondary hydrogen fuel tank 106 during refueling of the plurality of primary hydrogen fuel tanks 102.

The secondary hydrogen fuel tank 106 and the plurality of primary hydrogen fuel tanks 102 collectively provide hydrogen fuel to the primary fuel consumer 104 and the secondary fuel consumer 110. A check valve or a combined check valve and solenoid valve, collectively called CSV 108, is between the plurality of primary hydrogen fuel tanks 102 and the secondary hydrogen fuel tank 106. When the CSV 108 is operating as a check valve, the check valve opens at a defined opening pressure. During normal operation, the CSV 108 is closed and the plurality of primary hydrogen fuel tanks 102 are connected to the secondary hydrogen fuel tank 106.

In these embodiments, an inline solenoid valve is connected to each fuel consumer. For example, inline solenoid valve 114 is connected to primary fuel consumer 104 and inline solenoid valve 116 is connected to the secondary fuel consumer 110. The secondary fuel consumer 110 in some embodiments consists of more than one fuel consumer. During operation, the controller 112 commands the inline solenoid valves 114, 116 to be in a closed position to provide hydrogen fuel to the primary fuel consumer 104 and secondary fuel consumer 110, respectively. Thus, when inline solenoid valve 114 is in the closed position, hydrogen fuel is provided to the primary fuel consumer 102 as illustrated in FIG. 1. When the inline solenoid valve is in the open position, hydrogen fuel is not provided to the primary fuel consumer 102 as illustrated in FIG. 2.

During operation, the hydrogen fuel from the plurality of primary hydrogen fuel tanks 102 and the secondary hydrogen fuel tank 106 is provided to the primary fuel consumer 102 and, when the inline solenoid valve 116 is in the closed position, to the secondary fuel consumer 110. The pressure and flow conditioning block 118 can condition the hydrogen fuel pressure and flow.

When the plurality of primary hydrogen fuel tanks 102 need to be filled, the CSV 108 is opened and the inline solenoid valve 114 is opened in some embodiments. This allows the plurality of primary hydrogen fuel tanks 102 to be refueled while the secondary fuel consumer 110 is provided hydrogen fuel. In other embodiments, the controller 112 directs the primary fuel consumer 104 to reduce hydrogen fuel draw during refueling and the inline solenoid valve 114 remains in the closed position during refueling.

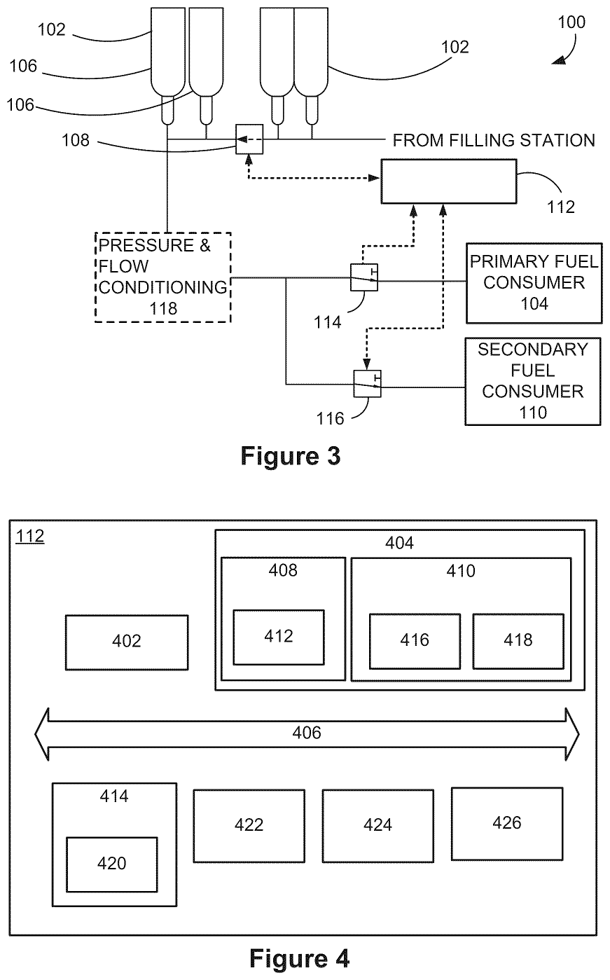

Note that if the at least one secondary hydrogen fuel tank is too small, the CSV 116 can be positioned upstream of additional primary hydrogen fuel tanks 102 as illustrated in FIG. 3.

FIG. 4 is a schematic diagram of a controller 112 for implementing examples disclosed herein. The controller 112 is adapted to execute instructions from a computer-readable medium to perform these and/or any of the functions or processing described herein. The controller 112 may be connected (e.g., networked) to other machines in a LAN, an intranet, an extranet, or the Internet. While only a single device is illustrated, the controller 112 may include any collection of devices that individually or jointly execute a set (or multiple sets) of instructions to perform any one or more of the methodologies discussed herein.

The controller 112 may comprise any computing or electronic device capable of including firmware, hardware, and/or executing software instructions to implement the functionality described herein. The controller 112 includes a processor device 402 (may also be referred to as a control unit or processing circuitry), a memory 404, and a system bus 406. The system bus 406 provides an interface for system components including, but not limited to, the memory 404 and the processor device 402. The processor device 402 may include any number of hardware components for conducting data or signal processing or for executing computer code stored in memory 404. The processor device 402 (i.e., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processor device 402 (e.g., via a circuit or any other wired, wireless, or network connection) and may include computer code for executing one or more processes described herein. The memory 404 may include non-volatile memory 308 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with a processor device 402. A basic input/output system (BIOS) 412 may be stored in the non-volatile memory 308 and can include the basic routines that help to transfer information between elements within the controller 112.

The controller 112 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

A number of modules can be stored in the storage device 414 and in the volatile memory 410, including an operating system 416 and one or more program modules 418, which may implement the functionality described herein in whole or in part. All or a portion of the examples disclosed herein may be implemented as a computer program product 420 stored on a transitory or non-transitory computer-usable or computer-readable storage medium (i.e., single medium or multiple media), such as the storage device 414, which includes complex programming instructions, such as complex computer-readable program code, to cause the processor device 402 to carry out the steps described herein. Thus, the computer-readable program code can comprise software instructions for implementing the functionality of the examples described herein when executed by the processor device 402. The processor device 402 may serve as a controller, or control system, for the controller 112 that is to implement the functionality described herein.

The controller 112 also may include an input device interface 422 (e.g., input device interface and/or output device interface). The input device interface 422 may be configured to receive input and selections to be communicated to the controller 112 when executing instructions, such as from a keyboard, mouse, touch-sensitive surface, etc. Such input devices may be connected to the processor device 402 through the input device interface 422 coupled to the system bus 406 but can be connected through other interfaces such as a parallel port, an Institute of Electrical and Electronic Engineers (IEEE) 1394 serial port, a Universal Serial Bus (USB) port, an IR interface, and the like. The controller 112 may include an output device interface 424 configured to forward output, such as to a display, a video display unit (e.g., a liquid crystal display (LCD) or a cathode ray tube (CRT)). The controller 112 may also include a communications interface 326 suitable for communicating with a network as appropriate or desired.

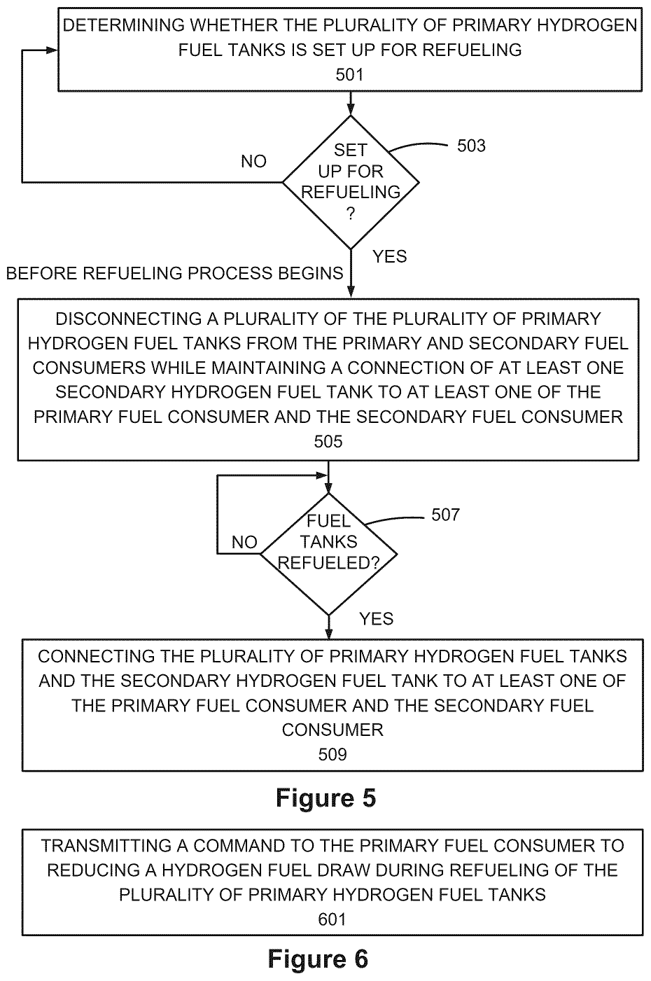

FIG. 5 illustrates operations the controller 112 performs in some embodiments such as the embodiments illustrated in FIGS. 1-3 during a refueling process. Turning to FIG. 5, in block 501, the controller 112 determines whether the plurality of primary hydrogen fuel tanks is set up for refueling. When the plurality is set up for refueling and illustrated in block 503 and before the refueling process starts, the controller 112 disconnects a plurality of the plurality of primary hydrogen fuel tanks 102 from the primary fuel consumer while maintaining a connection of the secondary hydrogen fuel tank 106 to at least one of the primary fuel consumer 104 and the secondary fuel consumer 110. In other words, all of the plurality of primary fuel tanks 102 except for the at least one primary hydrogen fuel tank of the plurality of primary hydrogen fuel tanks 102 acting as the secondary hydrogen fuel tank (106) are disconnected for fueling the primary fuel consumer 104 and the secondary fuel consumer 110.

In some embodiments, the controller 112 disconnects the plurality of the plurality of primary hydrogen fuel tanks 102 by commanding the CSV 108 to open. When the controller 112 determines that the plurality of the plurality of primary hydrogen fuel tanks 102 has been refueled, the controller 112 in block 509 connects the plurality of the plurality of primary hydrogen fuel tanks 102 and the secondary hydrogen fuel tank 106 to at least one of the primary fuel consumer 102 and the secondary fuel consumer 110.

In other embodiments, the controller 112 directs the primary fuel consumer 104 to reduce hydrogen fuel draw during refueling and the inline solenoid valve 114 remains in the closed position during refueling. This is illustrated in FIG. 6 where in block 601, the controller 112 transmits a command to the primary fuel consumer 102 to reduce a hydrogen fuel draw during refueling of the plurality of primary hydrogen fuel tanks 102.

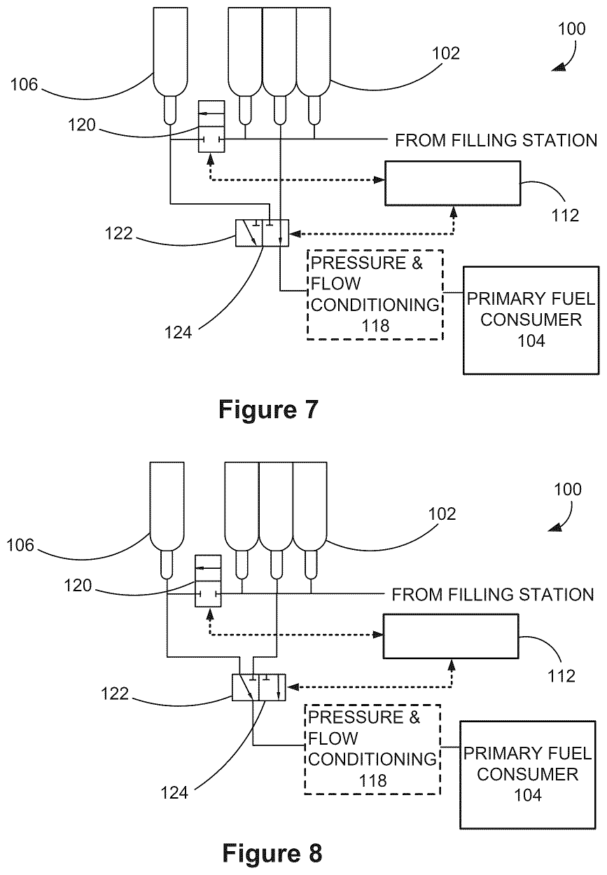

FIG. 7 illustrates another embodiment of a continuous hydrogen delivery system 100 where a plurality of primary hydrogen fuel tanks 102 are providing hydrogen fuel to a primary fuel consumer 104 according to one example. In this embodiment, the at least one secondary hydrogen fuel tank 106 is not part of the plurality of primary hydrogen fuel tanks. In other words, the at least one secondary hydrogen fuel tank is separated from the plurality of primary hydrogen fuel tanks 102. In FIG. 7, the plurality of primary hydrogen fuel tanks 102 are connected to the at least one secondary hydrogen fuel tank 106 via a switchable two port two position valve 120. In a first position of the switchable two port two position valve 120, the plurality of primary hydrogen fuel tanks 102 are not connected to the at least one secondary hydrogen fuel tank 106. The controller 112 maintains the switchable two port two position valve 120 in the first position during normal operation. When the at least one secondary hydrogen fuel tanks needs to be refueled from the filling station, the controller changes the switchable two port two position valve 120 to be in the second position where the at least one secondary hydrogen fuel tank is connected to the plurality of primary hydrogen fuel tanks 102. The plurality of primary hydrogen fuel tanks 102 and the at least one secondary fuel tank 106 are connected to ports of a multiple port multiple position valve 122. In FIG. 1 (and FIG. 2), the multiple port multiple position valve 122 is a two port two position valve which will be designated as two port two position valve 124.

FIG. 7 shows the two port two position valve 124 being in a first position where the plurality of primary hydrogen fuel tanks is connected to the primary fuel consumer 104 and the at least one secondary hydrogen fuel tank 106 is disconnected.

FIG. 8 shows the two port two position valve 124 being in a second position where the plurality of primary hydrogen fuel tanks is disconnected from the primary fuel consumer 104 and the at least one secondary hydrogen fuel tank 106 is connected to the primary fuel consumer 104. This enables the plurality of primary hydrogen fuel tanks to be refueled from a filling station. The pressure and flow conditioning block 118 can condition the hydrogen fuel pressure and flow.

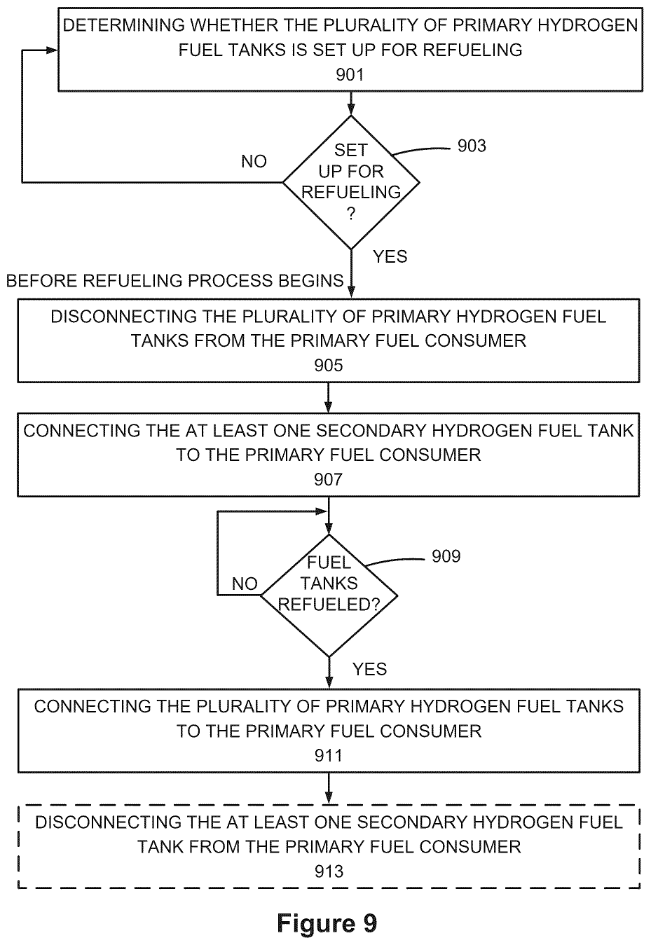

FIG. 9 illustrates operations the controller 112 performs in some embodiments such as the embodiments illustrated in FIGS. 7 and 8. Turning to FIG. 9, in block 901, the controller 112 determines whether the plurality of primary hydrogen fuel tanks 102 is set up for refueling. Responsive to determining that the plurality of primary hydrogen fuel tanks 102 is set up for refueling as represented by the yes path of block 903 in FIG. 9 and before the refueling process begins, the controller 112 in block 905 disconnects the plurality of primary hydrogen fuel tanks 102 from the primary fuel consumer. For example, as illustrated in FIGS. 7 and 8, by commanding the two port two position valve 124 to move from the first position to a second position (shown in FIG. 8), the plurality of primary hydrogen fuel tanks 102 are disconnected from the primary fuel consumer. In block 907, the controller 112 connects the at least one secondary hydrogen fuel tank to the primary fuel consumer, thereby maintaining availability of hydrogen to the primary fuel consumer during refueling of the plurality of primary hydrogen fuel tanks. As can be seen in FIG. 8, by commanding the two port two position valve 124 to move from the first position to a second position, the at least one secondary hydrogen fuel tank 106 becomes connected to the primary fuel consumer. If the plurality of primary hydrogen fuel tanks 102 are not set up for refueling, the controller 112 may periodically check to determine if the plurality of primary hydrogen fuel tanks 102 are set up for refueling. In some embodiments, the controller 112 may receive an indication that the plurality of primary hydrogen fuel tanks 102 are being set up for refueling.

After the plurality of primary hydrogen fuel tanks 102 have been refueled, the controller 112 in block 909 disconnects the at least one secondary hydrogen fuel tank from the primary fuel tank and connects the plurality of primary hydrogen fuel tanks 102 to the primary fuel consumer 104 in block 911. For example, as illustrated in FIGS. 7 and 8, by commanding the two port two position valve 124 to move from the second position to the first position the plurality of primary hydrogen fuel tanks 102 is connected to the primary fuel consumer 104 and in some embodiments as illustrated in block 913, the at least one secondary hydrogen fuel tank 106 is disconnected from the primary fuel consumer.

The primary fuel consumer may be a fuel cell electric vehicle.

In some embodiments, a secondary fuel consumer may be present. For example, the secondary fuel consumer can be a hydrogen catalytic heater.

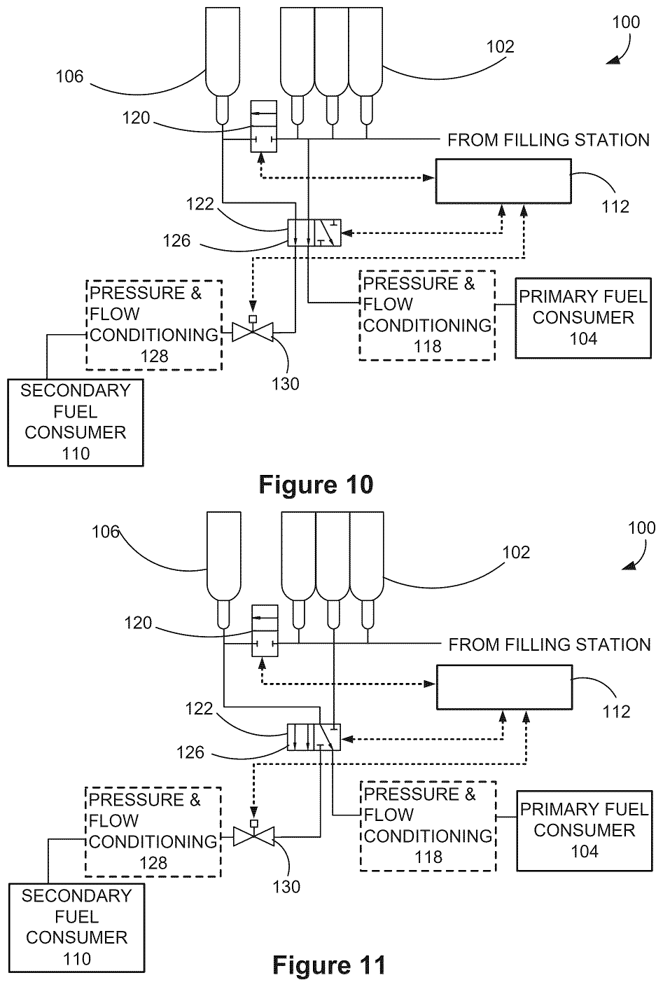

FIGS. 10 and 11 illustrate embodiments where the multiple port multiple position valve 120 is a three port, two position valve 116. In FIG. 10, when the three port, two position valve 126 is in a first position, the plurality of primary hydrogen fuel tanks 102 is connected to the primary fuel consumer 104 and at least one secondary hydrogen fuel tank 106 is connected to the secondary fuel consumer 110. In the flow path to the secondary fuel consumer, a second pressure and flow conditioning block 128 may be present. Additionally, a fuel shut off valve 130 may also be in the flow path that enables the controller 112 to disconnect the secondary fuel consumer 110 from the continuous hydrogen delivery system 100.

In FIG. 11, when the three port, two position valve 126 is in a second position, the plurality of primary hydrogen fuel tanks 102 is disconnected from the primary fuel consumer 104 and at least one secondary hydrogen fuel tank 106 is connected to the primary fuel consumer 104 and disconnected from the secondary fuel consumer 110.

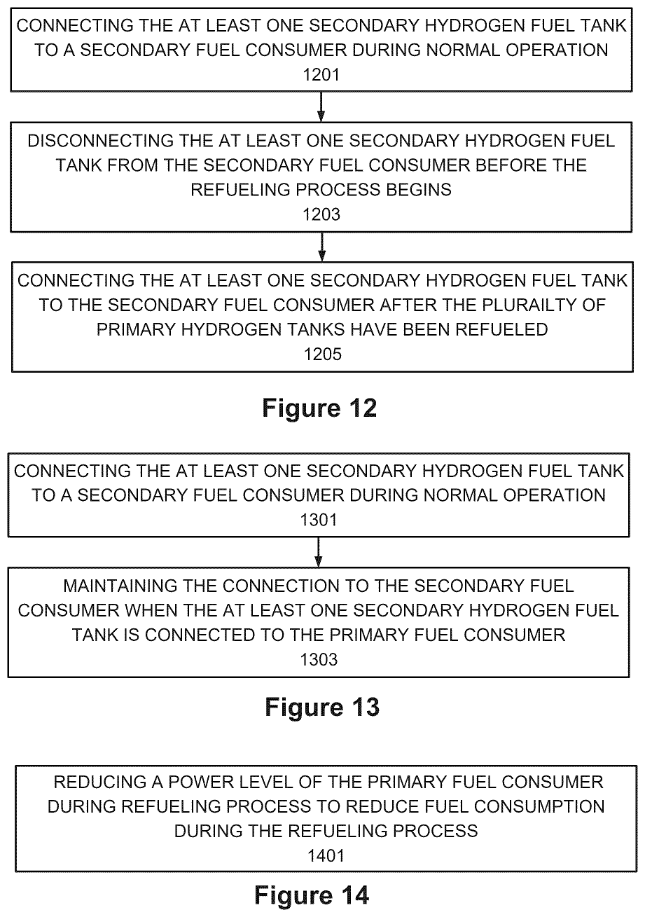

FIG. 12 illustrates operations the controller 112 may perform with the embodiments illustrated in FIGS. 10 and 11. Turning to FIG. 12, in block 1201, the controller 112 connects the at least one secondary hydrogen fuel tank 106 to the secondary fuel consumer 110 during normal operation. In block 1203, the controller 112 disconnects the at least one secondary hydrogen fuel tank 106 from the secondary fuel consumer 110 before the refueling process of the plurality of primary hydrogen fuel tanks 102 begins. In block 1205, the controller 112 connects at least one secondary hydrogen fuel tank 106 to the secondary fuel consumer 110 after the plurality of primary hydrogen fuel tanks 102 have been refueled.

There may be scenarios where during normal operation, the plurality of primary hydrogen fuel tanks 102 is connected to the primary fuel consumer and the at least one secondary hydrogen fuel tank 106 is connected to the secondary fuel consumer 110. During the time the plurality of primary hydrogen fuel tanks is being refueled, there may be situations where only the primary fuel consumer 104 is to be supplied hydrogen fuel, where only the secondary fuel consumer 110 is to be suppled hydrogen fuel, or both the primary fuel consumer 104 and the secondary fuel consumer 110 are to be supplied hydrogen fuel.

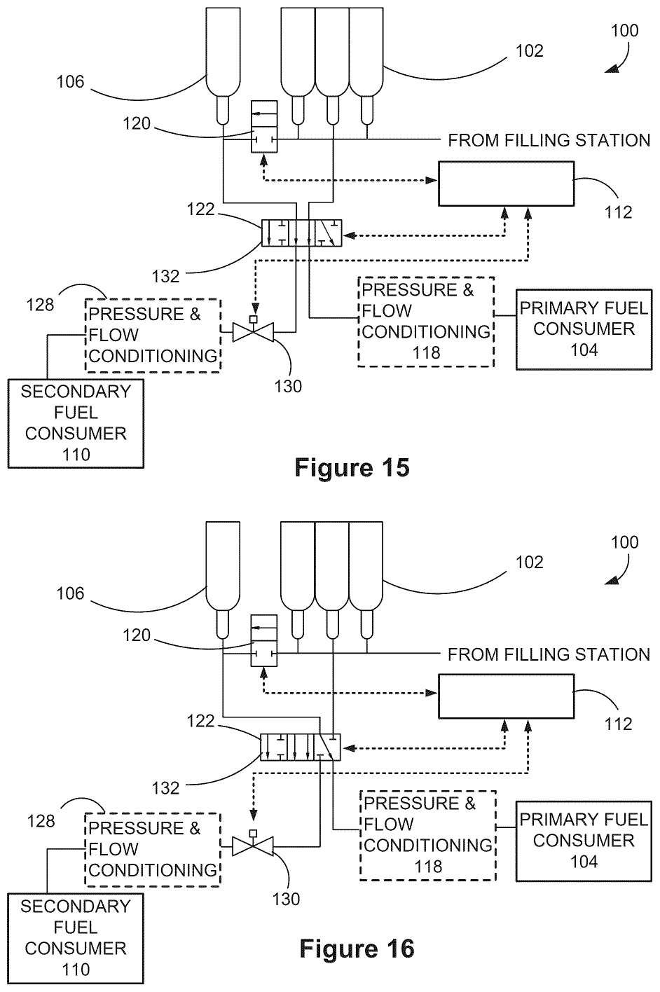

The operations of the controller 112 in the last scenario of both the primary fuel consumer and the secondary fuel consumer are to be supplied hydrogen fuel is illustrated in FIG. 13. Turning to FIG. 15, in block 1301, the controller 112 connects the at least one secondary hydrogen fuel tank 106 to the secondary fuel consumer 110 during normal operation. In block 1303, the controller 112 maintains the connection of the secondary fuel consumer 110 to the at least one secondary hydrogen fuel tank when the at least one secondary hydrogen fuel tank 106 is connected to the primary fuel consumer 104.

In some embodiments, the power level of the primary fuel consumer is reduced during refueling. This is illustrated in FIG. 14. Turning to FIG. 14, in block 1401, the controller 112 reduces a power level of the primary fuel consumer 104 during the refueling process to reduce fuel consumption during the refueling process. For example, the controller 112 may transmit a command to the primary fuel consumer 104 to reduce hydrogen fuel draw during refueling of the plurality of primary hydrogen fuel tanks 102.

For the scenarios described above, a four port, three position valve 120 is used for the multiple position multiple valve 110. FIG. 15 shows the four port, three position valve 132 in a first position. In the first position, the plurality of primary hydrogen fuel tanks 102 provides hydrogen fuel to the primary fuel consumer 104 and the at least one secondary hydrogen fuel tank 106 provides hydrogen fuel to the secondary fuel consumer 110.

FIG. 16 shows the four port, three position valve 132 in a second position. In the second position, the plurality of primary hydrogen fuel tanks 102 is disconnected from the primary fuel consumer 104 and the secondary fuel consumer 110. The at least one secondary hydrogen fuel tank 106 is connected to the primary fuel consumer 104 and provides hydrogen fuel to the primary fuel consumer 104 but does not provide hydrogen fuel to the secondary fuel consumer 110.

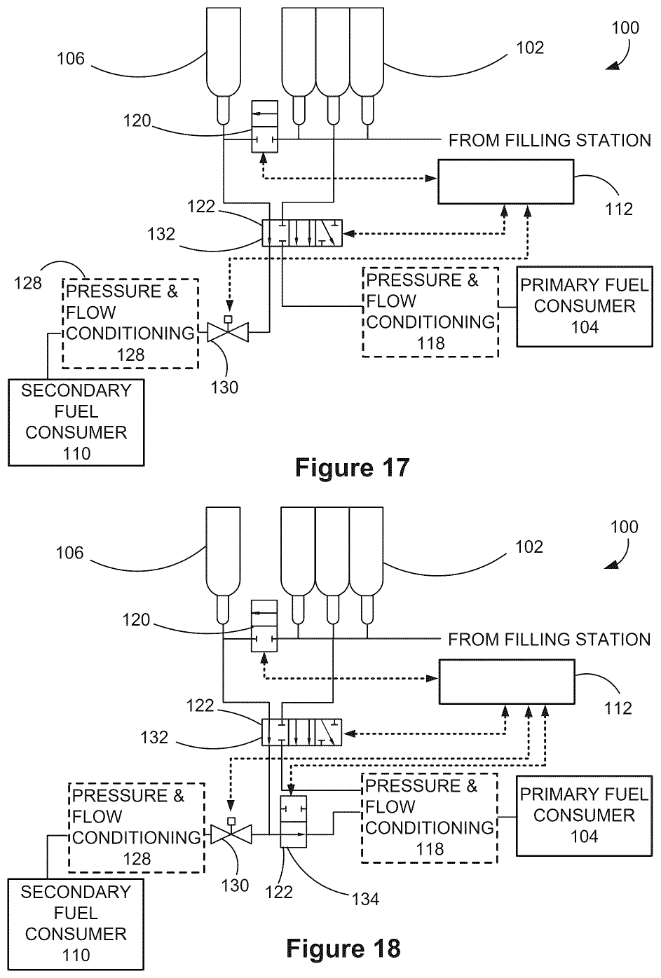

FIG. 17 shows the four port, three position valve 132 in a third position. In the third position, the plurality of primary hydrogen fuel tanks 102 is disconnected from the primary fuel consumer 104 and the secondary fuel consumer 110. The at least one secondary hydrogen fuel tank 106 is connected to the secondary fuel consumer 110 but does not provide fuel to the primary fuel consumer 104.

FIG. 18 illustrates a second two port two position valve 134 being added to the continuous hydrogen delivery system 100 between the primary fuel consumer and the hydrogen fuel flowing when the four port, three position valve 132 is in the third position. In a first position of the second two port two position valve 134, the primary fuel consumer 104 is disconnected from the hydrogen fuel flowing when the four port, three position valve 132 is in the third position. However, when the second two port two position valve 134 is in a second position as illustrated in FIG. 18, the at least one secondary hydrogen fuel tank 106 provides hydrogen fuel to both the primary fuel consumer 104 and the secondary fuel consumer 110.

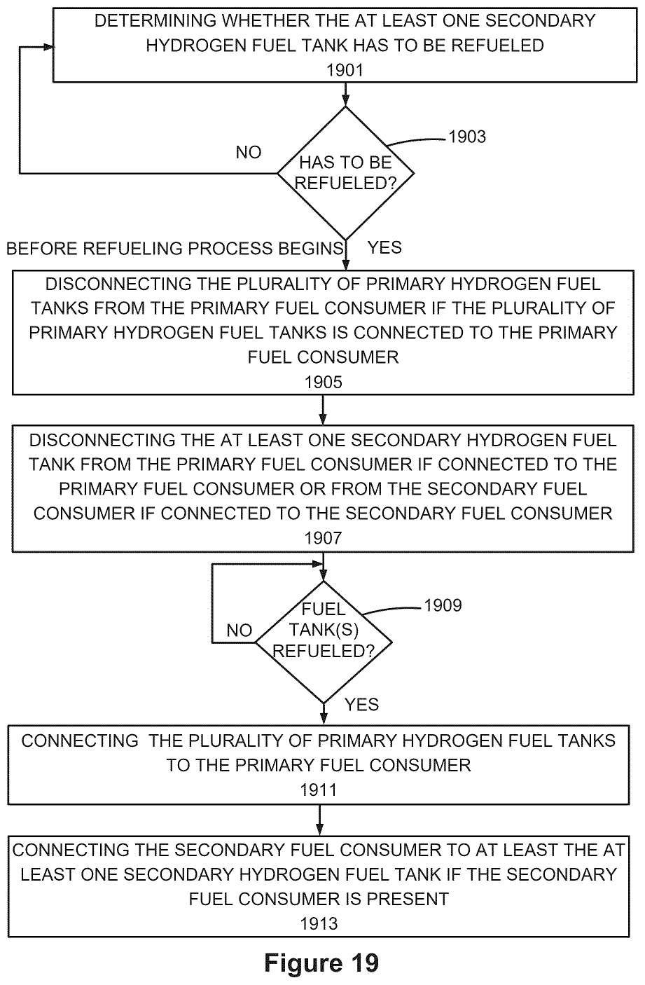

In some embodiments, the at least one secondary hydrogen fuel tank 106 needs to be refueled. The operations the controller 112 performs is illustrated in FIG. 19. Turning to FIG. 19, in block 1901, the controller 112 determines whether the at least one secondary hydrogen fuel tank 106 has to be refueled. Responsive to determining that the at least one secondary hydrogen fuel tank 106 has to be refueled as represented by the yes path in block 1903 and before the refueling process begins, the controller 112 in block 1905 disconnects the plurality of primary hydrogen fuel tanks 102 from the primary fuel consumer 104 if the plurality of primary hydrogen fuel tanks is connected to the primary fuel consumer. The controller 112 in block 1907 disconnects the at least one secondary hydrogen fuel tank 106 from the primary fuel consumer 104 if connected to the primary fuel consumer 104 or from the secondary fuel consumer 110 if connected to the secondary fuel consumer 110.

The controller check to determine if the at least one secondary hydrogen fuel tank has been refueled in block 1909. Responsive to determining that the at least one secondary hydrogen fuel tank 106 has been refueled as represented by the yes path, the controller 112 in block 1911 connects the plurality of primary hydrogen fuel tanks 102 to the primary fuel consumer 104. In block 1913, the controller 112 connects the secondary fuel consumer 110 to at least the at least one secondary hydrogen fuel tank 106 if the secondary fuel consumer 110 is present.

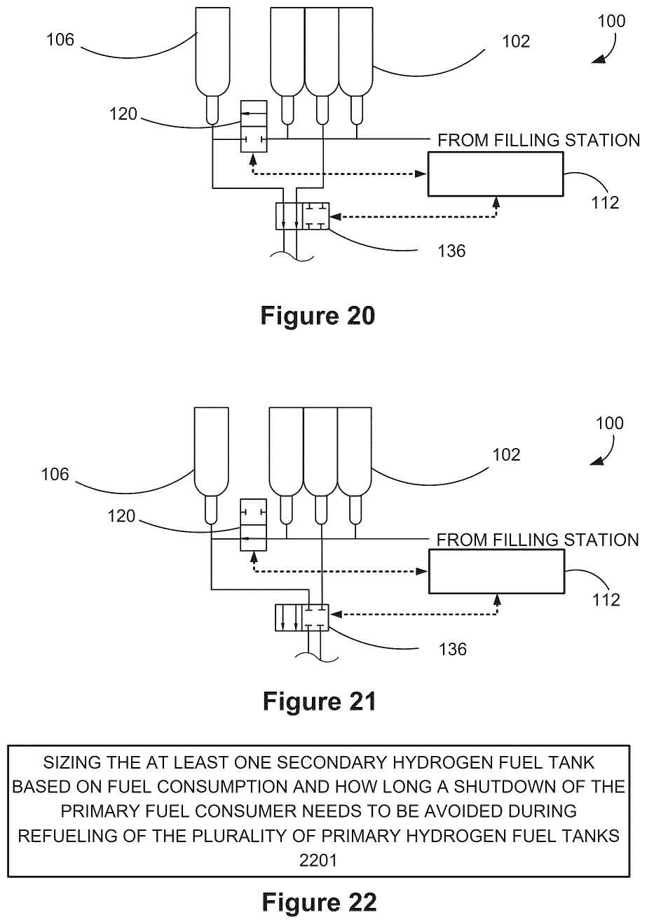

FIGS. 20 and 21 illustrate a portion of the continuous hydrogen delivery system 100 in refueling the at least one secondary hydrogen fuel tank 106. During normal operation as illustrated in FIG. 20, the first two port two position valve 120 is in the first position. The second four port two position valve 136 added to the continuous hydrogen delivery system 100 (and not shown in FIGS. 7-8, 10-11, and 15-18 for clarity) is in a first position where the plurality of primary hydrogen fuel tanks 102 and the at least one secondary hydrogen fuel tank 106 provide hydrogen fuel to the primary fuel consumer 102 or to the primary fuel consumer 104 and the secondary fuel consumer 110.

FIG. 21 illustrates the first two port two position valve 120 being in the second position and the second four port two position valve 136 is in a second position. The first two port two position valve 120 being in the second position connects the at least one secondary hydrogen fuel tank 106 to the plurality of primary hydrogen fuel tanks 102 and the filling station. The second four port two position valve 136 being in the second position disconnects the plurality of primary hydrogen fuel tanks 102 and the at least one secondary hydrogen fuel tank 106 from providing fuel to the primary fuel consumer 104 and the secondary fuel consumer 110. After the at least one secondary hydrogen fuel tank 106 has been refueled, the controller 112 commands the first two port two position valve 120 to move to the first position and the second four port two position valve 136 to move to the first position. The end result is that the first two port two position valve 120 and the second four port two position valve 136 are in the positions shown in FIG. 23.

FIG. 22 illustrates sizing the at least one secondary hydrogen fuel tank based on fuel consumption. Turning to FIG. 22, in block 2201, the at least one secondary hydrogen fuel tank is sized based on fuel consumption and how long a shutdown of the primary fuel consumer needs to be avoided during refueling of the plurality of primary hydrogen fuel tanks.

The operational steps described in any of the exemplary embodiments herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

It is to be understood that the present invention is not limited to the embodiments described above and illustrated in the drawings; rather, the skilled person will recognize that many changes and modifications may be made within the scope of the present disclosure and appended claims.

1. A method in a continuous hydrogen delivery system having a plurality of primary hydrogen fuel tanks and at least one primary hydrogen fuel tank of the plurality of primary hydrogen fuel tanks acting as a secondary hydrogen fuel tank during refueling to maintain availability of hydrogen to one or more fuel consumers during refueling of a plurality of the plurality of primary hydrogen fuel tanks, the method performed by a controller and comprising:
determining whether the plurality of primary hydrogen fuel tanks is set up for refueling;
responsive to determining that the plurality of primary hydrogen fuel tanks is set up for refueling:
before the refueling process begins:
disconnecting a plurality of the plurality of primary hydrogen fuel tanks from a primary fuel consumer and a secondary fuel consumer while maintaining a connection of the secondary hydrogen fuel tank to at least one of the primary fuel consumer and the secondary fuel consumer; and
after the plurality of primary hydrogen tanks have been refueled:
connecting the plurality of the plurality of primary hydrogen fuel tanks and the secondary hydrogen fuel tank to at least one of the primary fuel consumer and the secondary fuel consumer.

2. The method of claim 1 wherein disconnecting the plurality of the plurality of primary hydrogen fuel tanks from the primary fuel consumer comprises commanding a valve to close to prevent hydrogen fuel to flow through the valve.

3. The method of claim 1, further comprising transmitting a command to the primary fuel consumer to reducing a hydrogen fuel draw during refueling of the plurality of primary hydrogen fuel tanks.

4. The method of claim 1, wherein maintaining the connection of the at least one secondary hydrogen fuel tank to one of the primary fuel consumer and the secondary fuel consumer comprises maintaining the connection of the at least one secondary hydrogen fuel tank to the secondary fuel consumer.

5. A continuous hydrogen delivery system comprising:
a plurality of primary hydrogen fuel tanks configured to provide hydrogen fuel to a primary fuel consumer and a secondary fuel consumer;
at least one primary hydrogen fuel tank of the plurality of primary hydrogen fuel tanks configured to act as a secondary hydrogen fuel tank during refueling to maintain availability of hydrogen to one or more fuel consumers during refueling of a plurality of the plurality of primary hydrogen fuel tanks;
a first valve connected between the plurality of primary hydrogen fuel tanks and the secondary hydrogen fuel tank;
a second valve connected between the plurality of primary hydrogen fuel tanks and the primary fuel consumer;
a third valve connected between the plurality of primary hydrogen fuel tanks and the secondary fuel consumer; and
a controller configured to perform operations comprising:
determining whether the plurality of primary hydrogen fuel tanks is set up for refueling;
responsive to determining that the plurality of primary hydrogen fuel tanks is set up for refueling:
before the refueling process begins:
disconnecting a plurality of the plurality of primary hydrogen fuel tanks from the primary fuel consumer while maintaining a connection of the secondary hydrogen fuel tank to at least one of the primary fuel consumer and the secondary fuel consumer; and
after the plurality of primary hydrogen tanks have been refueled:
connecting the plurality of the plurality of primary hydrogen fuel tanks and the secondary hydrogen fuel tank to at least one of the primary fuel consumer and the secondary fuel consumer.

6. The continuous hydrogen delivery system of claim 5 wherein the controller is configured to disconnect the plurality of the plurality of primary hydrogen fuel tanks from the primary fuel consumer by commanding the first valve to open.

7. The continuous hydrogen delivery system of claim 5, wherein the controller is further configured to transmit a command to the primary fuel consumer to reduce a hydrogen fuel draw during refueling of the plurality of primary hydrogen fuel tanks.

8. The continuous hydrogen delivery system of claim 6, wherein the controller is configured to maintain the connection of the at least one secondary hydrogen fuel tank to one of the primary fuel consumer and the secondary fuel consumer by maintaining the connection of the at least one secondary hydrogen fuel tank to the secondary fuel consumer.

9. A method in a continuous hydrogen delivery system having a plurality of primary hydrogen fuel tanks and at least one secondary hydrogen fuel tank to maintain availability of hydrogen to a primary fuel consumer during refueling of at least one of the plurality of primary hydrogen fuel tanks, the method performed by a controller and comprising:
determining whether the plurality of primary hydrogen fuel tanks is set up for refueling;
responsive to determining that the plurality of primary hydrogen fuel tanks is set up for refueling:
before the refueling process begins:
disconnecting the plurality of primary hydrogen fuel tanks from the primary fuel consumer; and
connecting the at least one secondary hydrogen fuel tank to the primary fuel consumer, thereby maintaining availability of hydrogen to the primary fuel consumer during refueling of the plurality of primary hydrogen fuel tanks; and
after the plurality of primary hydrogen tanks have been refueled:
connecting the plurality of primary hydrogen fuel tanks to the primary fuel consumer.

10. The method of claim 9 further comprising disconnecting the at least one secondary hydrogen fuel tank from the primary fuel consumer after the plurality of primary hydrogen tanks have been refueled.

11. The method of claim 9 wherein the primary fuel consumer comprises a fuel cell electric vehicle.

12. The method of claim 9, further comprising:
connecting the at least one secondary hydrogen fuel tank to a secondary fuel consumer during normal operation;
disconnecting the at least one secondary hydrogen fuel tank from the secondary fuel consumer before the refueling process begins; and
connecting the at least one secondary hydrogen fuel tank to the secondary fuel consumer after the plurality of primary hydrogen tanks have been refueled.

13. The method of claim 9, further comprising:
connecting the at least one secondary hydrogen fuel tank to a secondary fuel consumer during normal operation; and
maintaining the connection to the secondary fuel consumer when the at least one secondary hydrogen fuel tank is connected to the primary fuel consumer.

14. The method of claim 9 wherein the secondary fuel consumer comprises a hydrogen catalytic heater.

15. The method of claim 9, further comprising
reducing a power level of the primary fuel consumer during the refueling process to reduce fuel consumption during the refueling process.

16. The method of claim 9, further comprising:
determining whether the at least one secondary hydrogen fuel tank has to be refueled;
responsive to determining that the at least one secondary hydrogen fuel tank has to be refueled:
before the refueling process begins:
disconnecting the plurality of primary hydrogen fuel tanks from the primary fuel consumer; and
disconnecting the at least one secondary hydrogen fuel tank from the primary fuel consumer if connected to the primary fuel consumer or from the secondary fuel consumer if connected to the secondary fuel consumer; and
after the at least one secondary hydrogen fuel tank has been refueled:
connecting the plurality of primary hydrogen tanks to the primary fuel consumer.

17. The method of claim 16, further comprising connecting the secondary fuel consumer to at least the at least one secondary hydrogen tank if the secondary fuel consumer is present.

18. The method of claim 9, further comprising:
sizing the at least one secondary hydrogen fuel tank based on fuel consumption and how long a shutdown of the primary fuel consumer needs to be avoided during refueling of the plurality of primary hydrogen fuel tanks.

19-38. (canceled)
